(19) United States
(12) Patent Application Publication
(10) Pub. No.: US 2011/0016528 A1
(43) Pub. Date: Jan. 20, 2011

(54) Method and Device for Intrusion Detection

(75) Inventors: Lidan Zhou, Beijing (CN); Bo Li, Beijing (CN); Runguo Ye, Beijing (CN); Tao Zhou, Beijing (CN)

Correspondence Address: Ling Wu, 1107 Bettstrail Way, Potomac, MD, 20854, US

(73) Assignees: Venus Info Tech Inc., Beijing (CN); Beijing Venus Information Security Technology Comp any Limited, Beijing (CN)

(21) Appl. No.: 12/920,462

(22) PCT Filed: Aug. 21, 2008
(86) PCT No.: PCT/CN2008/072091

§ 371 Date: Aug. 31, 2010

(30) Foreign Application Priority Data
Aug. 15, 2008 (CN) 200810117941.8

(51) Int. Cl. G06F 11/00

(52) U.S. Cl. 726/23

(57) ABSTRACT

A method and device for intrusion detection are provided. The method comprises: allocating one or more detection units for each type of network attack event to detect and configuring the type of object to detect of this type of network attack event, a detection operator and a detection knowledge base; in intrusion detection, acquiring network data packets in real time and acquiring the objects to detect included therein; then corresponding detection units performing intrusion detection according to the detection operators and detection knowledge bases configured, so as to generate network attack alarm events. The intrusion detection device comprises sequentially connected data pre-processing unit, data distribution unit and detection grid including one or more detection units, and a configuration management unit connected with them. The present invention supports accurate detection of various complex network attack events and considers the execution efficiency of the entire intrusion detection device.

### TECHNICAL FIELD

The present invention relates to the field of network attack detection, and more particularly, to a method and device for intrusion detection.

### BACKGROUND OF THE INVENTION

An intrusion detection device is a bypass or serially deployed network security device, and it is usually deployed inside a key network or at the entry of a network border to comprehensively monitor the network data packets going in or out of the network. All possible types of intrusion can be discovered by scanning and detecting the monitored network data packets, and a security policy or protective measures can be adjusted according to attack events. In addition, an attack event sequence generated by the intrusion detection device can provide a basis for regular security evaluation and analysis.

Current intrusion detection techniques applied in intrusion detection devices can be divided into two categories: misuse detection technique and abnormality detection technique. In the misuse detection technique, a security specialist extracts, according to attack instances collected, an attack signature string that can represent such type of attack event, and performs signature matching between a network data flow and the previously extracted attack signature string in real-time intrusion detection; if the matching is successful, it means a network attack event of such type is detected. In the abnormality detection technique, firstly a normal behavior profile is constructed for a monitored object, and then in real-time detection, the deviation between the current behavior profile of the detected object and the normal behavior profile is determined, and if the deviation exceeds a certain threshold, it means there is a network attack event. Since an abnormal event is not definitely a network attack event, and the intrusion detection method based on the abnormality detection technique has the problems that it is difficult to construct the normal behavior profile and the alarm is fuzzy, in practice, most intrusion detection devices are realized by applying the misuse detection technique.

A traditional intrusion detection device mainly comprises three units: an attack signature library unit, a data collection unit and an attack signature string matching unit. Wherein, the attack signature library unit stores attack signature strings extracted from known attack instances for use by the attack signature matching unit; the data collection unit captures network data packets from a monitored network in real time, and after flow reassembly and protocol parsing, sends the data to the attack signature matching unit; the attack signature matching unit scans and detects the data output from the data collection unit based on the attack signature library, and if the data flow is found including a known attack signature string, it means a network attack event of this type is detected.

Taking open source Snort intrusion detection product for example, a typical intrusion detection device uses a single format to describe attack signatures of all types of network attack events, and applies a traditional pattern matching technique to implement the matching operation between a network data flow and an attack signature string in real-time intrusion detection. Such intrusion detection mode based on a single attack signature string description format and a single pattern matching algorithm is being severely challenged by various network attack events nowadays, and particularly: 1) with the emergence of various network applications, especially the come-forth of Web-based network application systems, the diversity of network attack events is being widened, therefore, it is becoming more and more difficult to describe the attack signatures of all types of network attack events by a single format; 2) some network attack events have no obvious attack signature strings, or all the attack signature strings can not be enumerated, thus the attack signature strings can not be extracted by using the attack signature knowledge base of the misuse detection, for instance, the SQL injection attack and cross-site script attack events are impossible to define attack signatures by enumerating the attack signature strings, but other special detection knowledge bases should be used; 3) it becomes more and more difficult to apply the traditional pattern matching technique to implement complex attack signature string matching.

In order to support the intrusion detection of complex network attack events such as the SQL injection attack event, it is desirable to overcome the defects that the traditional intrusion detection device uses a single attack signature description format and a single attack signature matching technique. Some traditional intrusion detection devices support the detection of some complex network attack events through patches, however, the patches destroy the architectures of the traditional intrusion detection devices, and cause two problems: 1) with the joining in of more detection patches, the modularization of the entire intrusion detection device is getting worse, which will significantly increase the expense for maintaining and upgrading the intrusion detection device; 2) The coupling of the detection patches and the data collection unit in the traditional intrusion detection device is so strong that it severely affects the execution efficiency of the intrusion detection device.

Nowadays, it can be seen that some intrusion detection devices, such as the open source Bro and commercial NFR intrusion detection tools, use attack signature description languages similar to high-level languages to define the attack signatures of network attack events, which makes it possible to use a single format to describe all the attack signatures, however, these intrusion detection tools have to use the virtual machine technique to execute the matching between a network data flow and an attack signature string, resulting in a low intrusion detection efficiency.

### SUMMARY OF THE INVENTION

The technical problem to be solved by the present invention is to provide a method and device for intrusion detection which supports the accurate detection of all types of complex network attack events and takes the execution efficiency of the entire intrusion detection device into account.

In order to solve the above technical problem, the present invention provides a method for intrusion detection, comprising:

allocating one or more detection units in an intrusion detection device for each type of network attack event to detect;

configuring the type of object to detect of this type of network attack event, as well as a detection operator and a detection knowledge base to be used in intrusion detection of this type of object to detect; and

during the intrusion detection, said intrusion detection device performing the following processing:

acquiring network data packets in real time and pre-processing the network data packets to obtain the objects to detect in intrusion detection included in said network data packets; and

according to the types of the acquired objects to detect, corresponding detection units performing intrusion detection based on detection operators and detection knowledge bases configured for these types of objects to detect, and generating network attack alarm events.

Moreover, the above method may further comprise:

before the intrusion detection, generating a process tree of objects to detect according to the types of objects to detect configured, with leaf nodes of the process tree of objects to detect being objects to detect configured, and other nodes being intermediate objects required to be obtained during processing of the network data packets for obtaining the objects to detect corresponding to the lower layer leaf nodes; and

during the intrusion detection, said intrusion detection device only processing the intermediate objects in said process tree of objects to detect layer by layer to finally obtain the objects to detect in detection.

Moreover, the above method may further have the following features:

in said intrusion detection device, a multi-core hardware platform is employed for achieving parallel running of at least part of the detection units in intrusion detection.

Moreover, the above method may further comprise:

after generating the network attack alarm events, said intrusion detection device comprehensively analyzing the network attack alarm events to generate higher level network intrusion attack events.

Moreover, the above method may further comprise:

when pre-processing the acquired network data packets, said intrusion detection device collecting environmental information data of a monitored network, including a fingerprint of an operating system and/or a fingerprint of an application system; and

after generating the network attack alarm events, said intrusion detection device comprehensively analyzing the generated network attack alarm events by using said environmental information data to verify the validity of the attack events.

The present invention provides a device for intrusion detection of network attack events, comprising a data pre-processing unit, a data distribution unit and a detection grid which are connected sequentially, and a configuration management unit connecting with the data pre-processing unit, data distribution unit and detection grid, said detection grid comprising one or more detection units, wherein:

said configuration management unit comprises a customization subunit for allocating one or more detection units for each type of network attack event and configuring a type of object to detect of a type of network attack event to detect for each detection unit as well as a detection operator and a detection knowledge base to be used in intrusion detection;

said data pre-processing unit is used to pre-process network data packets acquired in real time according to the types of objects to detect configured, in order to obtain the objects to detect in intrusion detection included in the network data packets and transfer the objects to detect to said data distribution unit;

said data distribution unit is used to distribute the received objects to detect to corresponding detection units according to the types of objects to detect configured for the detection units; and

each of the detection unit in said detection grid is used to scan and detect the object to detect distributed to the detection unit by using the configured detection operator and detection knowledge base, so as to generate a network attack alarm event.

Moreover, the above device may further have the following features:

said configuration management unit further comprises a process tree generation subunit for generating a process tree of objects to detect according to the types of objects to detect configured, with leaf nodes of the process tree of objects to detect being the objects to detect configured, and other nodes being intermediate objects required to be obtained during processing of the network data packets for obtaining the objects to detect corresponding to the lower layer leaf nodes; and

when pre-processing the network data, said data pre-processing unit only processes the intermediate objects in said process tree of objects to detect layer by layer to obtain the objects to detect in detection.

Moreover, the above device may further have the following features:

said detection grid is realized based on a multi-core hardware platform, and at least part of the detection units can run in parallel during intrusion detection.

Moreover, the above device may further comprise a comprehensive analysis verification unit, wherein,

each of the detection units is further used to report the generated network attack alarm event to said comprehensive analysis verification unit; and

said comprehensive analysis verification unit is used to comprehensively analyze a network attack event sequence reported by the detection units to generate higher level network intrusion attack events.

Moreover, the above device may further have the following features:

when pre-processing the network data packets, said data pre-processing unit further collects environmental information data of a monitored network from the network data packets, the environmental information data including a fingerprint of an operating system and/or a fingerprint of an application system, and sends these environmental information data to said comprehensive analysis verification unit; and

when comprehensively analyzing said network attack alarm event sequence, said comprehensive analysis verification unit uses said environmental information data to comprehensively analyze the generated network attack alarm events, so as to verify the validity of the attack events.

Moreover, the above device may further have the following features:

said customization subunit is further used to reconfigure the detection units in the detection grid, including updating the detection operator and detection knowledge base of a detection unit, allocating a detection unit for a new type of network attack event and configuring the type of object to detect, the detection operator and the detection knowledge base, and releasing an allocated detection unit and deleting corresponding configuration information.

Moreover, the above device may further have the following features:

said customization subunit allocates one or more detection units for each type of network attack event according to the occurrence frequency of each type of network attack event, and configures the type of object to detect of this type of network attack event for these detection units; and

when a type of object to detect corresponds to a group of detection units with the same configuration, said data distribution unit distributes the object to detect to an idle detection unit in the detection units.

It can be seen that the present invention fully considers the diversity of the attack signatures of the current various network attack events and the characteristics that new types of attacks constantly emerge and become more and more complex, applies an intrusion detection mechanism of a layered management strategy, and allows using different description formats to describe the knowledge bases for all types of network attack events and using dedicated detection operators to implement intrusion detection of these types of network attack events. Compared with the traditional intrusion detection, the present invention can accomplish more accurate intrusion detection because it allows dedicated detection algorithms to be used for all types of network attack events. Moreover, the characteristics that the running of the multiple detection units in the intrusion detection device is independent of one another in the present invention enables full utilization of a multi-core hardware platform to improve the intrusion detection efficiency. Finally, the intrusion detection device provided in the present invention can enhance the capacity of detecting a type of network attack event by re-configuring the detection operator or detection knowledge base of a single detection unit, and can also support the detection of a new network attack event by adding a new detection unit, thus having excellent extensibility and largely decreasing the expense for maintaining and upgrading the intrusion detection device.

### BRIEF DESCRIPTION OF THE DRAWINGS

FIG. 1A is a schematic diagram illustrating the functional units of an intrusion detection device in accordance with an embodiment of the present invention;

FIG. 1B is a flow chart of an intrusion detection method in accordance with an embodiment of the present invention;

FIG. 2 is a flow chart of the processing of customizing a detection grid by the configuration management unit in FIG. 1A;

FIG. 3 is a schematic diagram of an instance of the detection grid customized for Web security detection specially;

FIG. 4 is a flow chart of the processing by the data pre-processing unit in FIG. 1A;

FIG. 5 is a schematic diagram of an instance of a process tree of objects to detect before being pruned;

FIG. 6 is a schematic diagram of an instance of a process tree of objects to detect obtained by pruning the process tree of objects to detect in FIG. 5 according to the result of customizing the detection grid;

FIG. 7 is a flow chart of the processing by the data distribution unit in FIG. 1A;

FIG. 8 is a flow chart of the processing by the detection unit in FIG. 1A;

FIG. 9 is a flow chart of the processing by the comprehensive analysis verification unit of the intrusion detection device in FIG. 1A.

### PREFERRED EMBODIMENTS OF THE PRESENT INVENTION

The intrusion detection method and device in accordance with the present invention applies an intrusion detection mechanism of a layered management strategy instead of the intrusion detection mechanism of a single attack signature description format and a single attack signature matching algorithm used by the traditional intrusion detection technique, allows applying different detection knowledge base description formats and selecting different attack detection operators for different types of network attack events to improve the detection accuracy and execution efficiency of the intrusion detection device.

Firstly, several terms used in the present invention will be interpreted below.

Object to detect, can be an application protocol message or a file flow object, where the application layer protocol message can be a HTTP request message, and the file flow object can be a HTML document object.

Detection operator, a software program designed for implementing the detection of a type of network attack event, uses a type of object to detect as input, scans and detects the object to detect according to a predefined detection knowledge base, so as to discover this type of network attack attempt hidden in the object to detect. The detection operator can be realized in the form of dynamic link library plug-in and provides a uniform detection call interface. Input parameters of the detection call interface include an object to detect and a detection knowledge base, and the output is a result of this detection.

Detection knowledge base, a detection knowledge set pre-created by the security specialist for implementing the detection of a type of network attack event and specially used by the detection operator of this type of network attack event. According to different detection principles, the detection knowledge base can be an attack signature knowledge base for implementing misuse detection, or a normal behavior profile knowledge base for abnormality detection.

All the detection operators configured for the detection units and the detection knowledge bases will instruct the corresponding detection units in the intrusion detection of some types of network attack events.

The embodiments of the present invention will be described in detail below in conjunction with the accompanying figures.

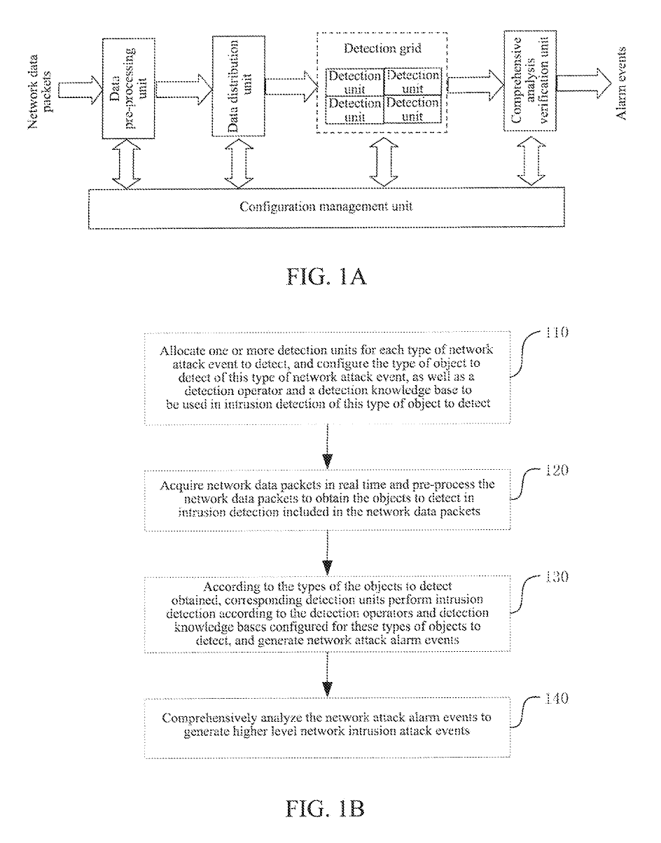

As shown in FIG. 1A, the intrusion detection device in this embodiment comprises a data pre-processing unit, a data distribution unit, a detection grid and a comprehensive analysis verification unit which are connected sequentially, and a configuration management unit capable of interacting with these units respectively, wherein the detection grid comprises one or more detection units, and wherein:

The configuration management unit comprises:

A customization subunit, used to customize the detection units in the detection grid, allocate one or more detection units for each type of network attack event during customization according to the type of the network attack event to detect, and for each detection unit, configure a type of object to detect of a type of network attack event and a detection operator and a detection knowledge base to be used in intrusion detection. The number of detection units to be allocated may depend on the occurrence frequency of each type of network attack event. The customization subunit is also used to reconfigure the detection units in the detection grid, including updating the detection operator and detection knowledge base of a detection unit, allocating a detection unit for a new type of network attack event and configuring the type of the object to detect, the detection operator and the detection knowledge base, and releasing an allocated detection unit and deleting the corresponding configuration information;

A process tree generation subunit, used to generate a layered process tree of objects to detect according to all the object to detect configured in customizing the detection unit, with leaf nodes of the process tree of objects to detect being the objects to detect by the detection units, and the other nodes being intermediate objects required to be obtained during processing of the network data packets for obtaining the objects to detect corresponding to the lower layer leaf nodes. A leaf node refers to a node without a child node.

The data pre-processing unit is used to acquire network data packets in real time, and pre-process the network data packets according to the process tree of objects to detect to obtain the objects to detect included therein and transfer them to the data distribution unit. The pre-processing of network data packets may comprise packet fragment processing, flow reassembly and deep level protocol parsing etc. The data pre-processing unit can also collect all kinds of environmental information data of a monitored network from buffered network data packets, the environmental information data including information of a fingerprint of an operating system and/or a fingerprint of an application system.

The data distribution unit is used to receive objects to detect, and distribute the received objects to detect to the corresponding detection units according to the types of the objects to detect allocated to the detection units in customizing the detection grid. When a type of object to detect corresponds to a group of detection units with the same configuration, the data distribution unit distributes the object to detect to one idle detection unit therein.

The detection units are used to detect the objects to detect distributed to them with preconfigured detection operators and detection knowledge bases, generate network attack alarm events and send them to the comprehensive analysis verification unit;

The comprehensive analysis verification unit is used to comprehensively analyze a network attack event sequence sent by the detection units to generate higher level network intrusion attack events. During the comprehensive analysis, various environmental information data are utilized to implement correlation analysis and validity verification of the network attack events.

It should be noted that the division of the above units is not unique, for example, the process tree of objects to detect generation subunit may also be included in the data pre-processing unit. But combinations of different units accomplishing the same functions, which are apparently equivalent to the above device, shall all fall within the protection scope of the present invention.

Based on the above intrusion detection device, the flow chart of the intrusion detection method in accordance with this embodiment is shown in FIG. 1B, and the method comprises the following steps:

Step 110, for each type of network attack event to detect, allocate one or more detection units in the intrusion detection device, and configure the type of the object to detect of this type of network attack event as well as the detection operator and detection knowledge base to be used in intrusion detection of this type of object to detect;

The above configuration makes it very convenient to perform operations such as modification, addition and deletion, for example, the versions of the detection units and/or detection knowledge bases configured for the detection units may be updated. When it is required to perform intrusion detection for a new type of network attack event, one or more detection units may be allocated for it, and the type of object to detect, detection operator and detection knowledge base may be configured correspondingly. When there is no need for intrusion detection of a configured type of network attack event, the detection unit allocated for this type of network attack event and the corresponding configuration information may be deleted.

A process tree of objects to detect is generated before the intrusion detection in this embodiment. Specifically, a process tree of objects to detect serving as a template may be configured first, the process tree comprising objects to detect of all types of network attack events and corresponding intermediate objects, these objects composing a tree structure according to the relationships among them. In order to generate a process tree of objects to detect in actual use, it is only required to prune the process tree of objects to detect serving as the template according to the actually customized objects to detect. In pruning, only the actually customized objects to detect and their upper-layer nodes are retained, and all other nodes will be deleted.

According to the occurrence frequency of each type of network attack event, one or more detection units may be allocated for each type of network attack event.

In intrusion detection, the intrusion detection device performs the following procedures:

Step 120, acquire network data packets in real time and pre-process the network data packets to obtain the objects to detect in intrusion detection included in the network data packets;

In this embodiment, the network data packets are pre-processed according to the generated process tree of objects to detect, and the pre-processing may include packet fragment processing, flow reassembly and deep level protocol parsing etc., with reference to the current processing method. Since only the intermediate objects in the process tree of objects to detect are processed during this process to obtain the objects to detect finally, the processing efficiency is largely improved.

Step 130, according to the types of the objects to detect obtained, corresponding detection units perform intrusion detection according to the detection operators and detection knowledge bases configured for these types of objects to detect, and generate network attack alarm events;

As mentioned before, when a type of object to detect corresponds to a group of detection units with the same configuration, the object to detect can be distributed to an idle detection unit therein for parallel processing. Therefore, when a type of network attack event occurs especially frequently, resources can be efficiently used. But one detection unit corresponds to only one type of network attack event, and its input is the object to detect of this type of network attack event.

Step 140, comprehensively analyze the network attack alarm events to generate higher level network intrusion attack events.

All kinds of environmental information data of a monitored network can be collected from buffered network data packets, the environmental information data including information of a fingerprint of an operating system and/or a fingerprint of an application system, and during the comprehensive analysis, various environmental information data can be utilized to implement correlation analysis and validity verification of the network attack events.

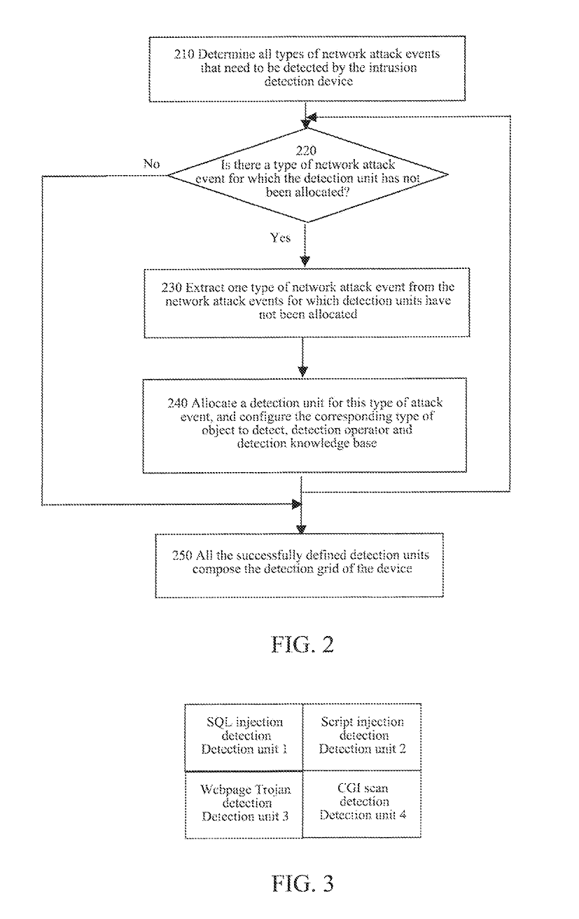

FIG. 2 is a flow chart of customizing a detection grid by the configuration management unit. Firstly, determine all types of network attack events that need to be detected by the intrusion detection device (step 210); then judge whether there is a type of network attack event for which the detection unit has not been allocated (step 220); if yes, extract one type of network attack event from a set of attack event types for which detection units have not been allocated (step 230); allocate a detection unit for this type of network attack event, and configure the type of object to detect required by the detection unit and the detection operator and the detection knowledge base for this type of object to detect, then return to step 220 (step 240); if there is no network attack event type for which the detection unit has not been allocated, then all the detection units with correct configuration compose the detection grid of the intrusion detection device (step 250).

FIG. 3 illustrates an instance of a detection grid specially for detecting Web type attacks. Herein, it is assumed that four types of Web attack events need to be detected: SQL (Structure Query Language) injection attack event, script injection attack event, webpage Trojan attack event and CGI (Common Gateway Interface) scan event. Hence four detection units are configured here for the detection grid, wherein, detection unit 1 is configured as SQL injection attack detection unit, of which the object to detect is HTTP (HyperText Transfer Protocol) request messages, the detection operator is a dedicated SQL injection attack detection algorithm designed and realized beforehand, and the detection knowledge base is a SQL injection attack signature library constructed beforehand; detection unit 2 is configured as script injection attack detection unit, of which the object to detect is HTTP request messages, the detection operator is a dedicated script injection attack detection algorithm designed and realized beforehand, and the detection knowledge base is a script injection attack signature library constructed beforehand; detection unit 3 is configured as webpage Trojan detection unit, of which the object to detect is HTML pages, the detection operator is a dedicated webpage Trojan detection algorithm designed and realized beforehand, and the detection knowledge base is a webpage Trojan virus signature library constructed beforehand; and detection unit 4 is configured as CGI scan detection unit, of which the object to detect is HTTP response message headers, the detection operator a dedicated CGI scan detection algorithm, and the detection knowledge base is a CGI scan attack signature library.

The configuration management unit also allows reconfiguration of the detection grid according to the users' security requirements, the reconfiguration including replacing the detection operator of a single detection unit and allocating a new detection unit to support the detection of a new type of network attack event. For example, as shown in FIG. 3, in order to upgrade the webpage Trojan detection algorithm in detection unit 3, it is only required to configure a new webpage Trojan detection operator and a new webpage Trojan virus signature library for detection unit 3. Alternatively, if XML (eXtensible Markup Language) injection attack detection needs to be added in the detection grid in FIG. 3, it is only required to add detection unit 5 and for detection unit 5, configure the object to detect as HTTP requests, configure the detection operator as a dedicated XML injection detection algorithm, and configure the detection knowledge base as a dedicated XML injection detection knowledge base.

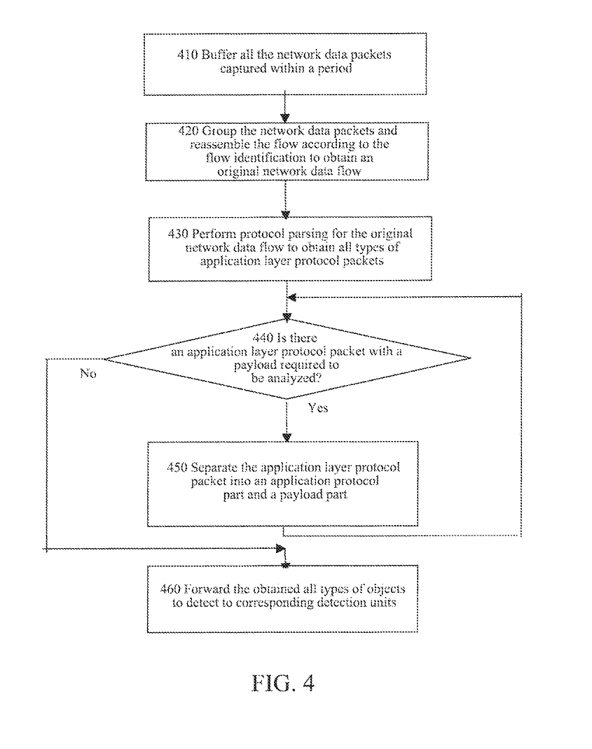

FIG. 4 is a flow chart of the processing by the data pre-processing unit. Firstly, the data pre-processing unit buffers all the network data packets captured within a period (step 410); then group the buffered network data packets and reassemble the flow according to the flow identification to obtain the original network data flow (step 420); and then perform deep level protocol parsing for the original data flow according to application protocol types indicated in the original network data flow to obtain all types of application layer protocol packets (step 430); judge whether there is an application layer protocol packet with a payload required to be analyzed (step 440); if yes, separate this application layer protocol packet into an application protocol part and a payload part, and return to step 440 (step 450); if not, send the obtained all types of objects to detect to the detection units (step 460). Herein, some application protocol packets having the capability of data transmission are required to be further separated into application protocol parts and payload parts, for example, an HTTP response message can be separated into an HTTP response message header part and an HTTP response payload part, wherein, the HTTP response message header is protocol status data of the HTTP protocol in response to an HTTP request; while the HTTP response payload is data sent by a Web server to a Web client to be finally presented to a user by the Web client.

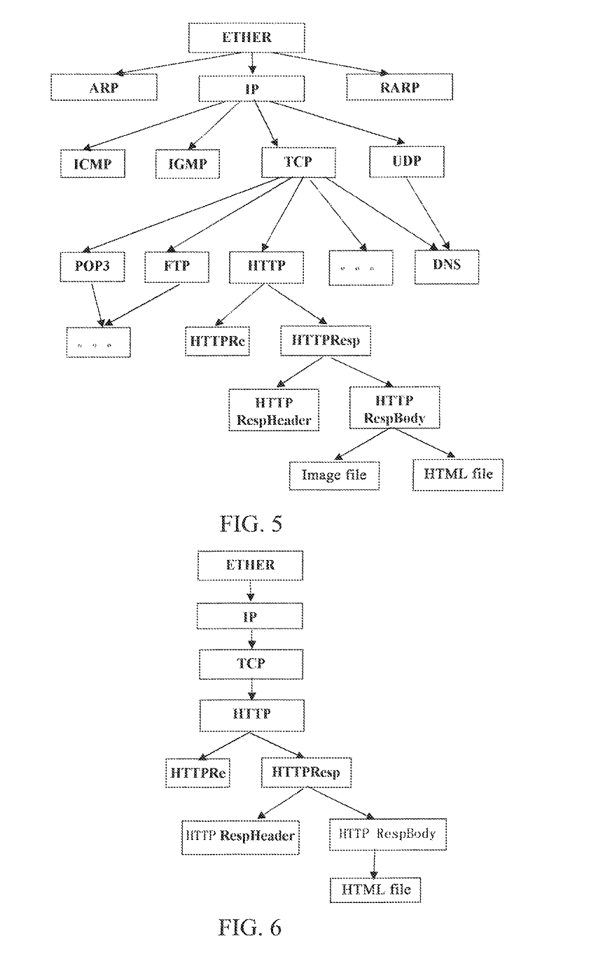

FIG. 5 shows an instance of the data pre-processing unit pre-processing the buffered network data packets and generating all types of objects to detect. In this instance, the Ethernet data packet is taken as example, the data pre-processing unit knows from the Ethernet header of an Ethernet packet that the packet is an IP (Internet Protocol) packet, an ARP (Address Resolution Protocol) packet or a RARP (Reverse Address Resolution Protocol) packet. The ARP packet and RARP packet themselves are final objects to detect and do not need further pre-processing, thus can directly be sent to an intrusion detection unit for intrusion detection. For the IP packet, packet fragment processing is performed first, then the fourth layer protocol type is known from the IP header of the IP packet, the fourth layer protocol type comprising ICMP (Internet Control Message Protocol), IGMP (Internet Group Message Protocol), TCP (Transport control Protocol) and UDP (User Datagram Protocol). The ICMP and IGMP type packets themselves are final objects to detect and do not need further pre-processing, thus can directly be sent to an intrusion detection unit for intrusion detection. For the TCP and UDP type packets, a connection identifier with a quaternion of source IP address, destination IP address, source port and destination port can be extracted from the IP header and TCP/UDP header, then the network data packets are grouped and the flow is reassembled based on the connection identifier to obtain the original data flow object; and finally, protocol parsing is performed on the obtained original data flow object according to application layer protocol types to obtain all types of application protocol messages, such as POP3 (Post Office Protocol Version 3), FTP (File Transfer Protocol), HTTP (HyperText Transfer Protocol) and DNS (Domain Name Service) etc. All the application protocol messages can generally be classified as request type or response type, for example, the HTTP protocol messages can be classified as HTTP request messages (HTTPReq) or HTTP response messages (HTTPResp), where the HTTP request message refers to an HTTP protocol message sent by a Web client to a Web server, and the HTTP response message refers to an HTTP protocol message returned by a Web server in response to a request from a Web client.

In addition, some application protocol packets having the capability of data transmission can further be separated into application protocol parts and payload parts, for example, an HTTP response message (HTTPResp) can be further be separated into an HTTP response header (HTTPRespHeader) part and an HTTP response payload (HTTPRespBody) part. Moreover, the application protocol payload parts can further be separated into all types of application protocol payload objects according to the types of payload, for example, an HTTP response payload can further be separated into an image file, an HTML file, and so on. The deep level protocol pre-processing for other types of application protocols is similar to that for the HTTP protocol, and will not be enumerated here for conciseness.

During implementation of the present invention, the data pre-processing unit does not need to generate all possible objects to detect, but may only generate the objects to detect required by the detection grid according to the process tree of objects to detect, which can largely improve the execution efficiency of the data pre-processing unit. For example, a detection grid shown in FIG. 3 only requires three types of objects to detect: HTTPReq, HTTPRespHeader and HTML file, therefore, the relevant data pre-processing unit is only required to generate all the objects to detect required by the detection grid according to the process tree of objects to detect shown in FIG. 6. FIG. 6 is obtained by pruning FIG. 5.

In addition, the data pre-processing unit can also collect all kinds of environmental information data of a monitored network from buffered network data packets, the environmental information data including information of the fingerprints of the operating system and application system, and send the environmental information to the comprehensive analysis verification unit for comprehensive analysis. Wherein, the fingerprint of the operating system can be acquired by detecting the TCP messages sent by the monitored host, for example, by directly using the open source pOf software packet; and the fingerprint information of the application system is acquired mainly by monitoring the version information returned by the monitored software service to the client.

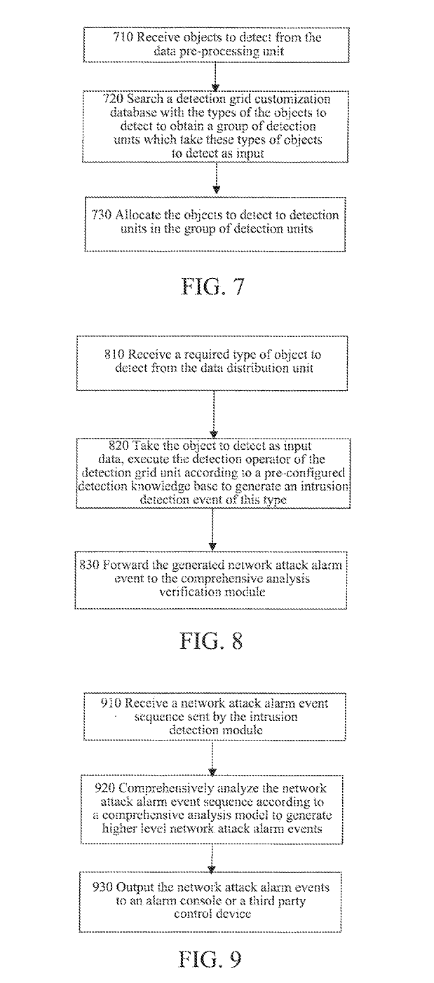

FIG. 7 is a flow chart of the processing by the data distribution unit. Firstly, receive objects to detect from the data pre-processing unit (step 710); then search a detection grid customization database according to the types of the objects to detect to obtain a group of detection units which take these types of objects to detect as input (step 720); finally, allocate these types of objects to detect to detection units in this group of detection units (step 730). When a type of object to detect corresponds to a group of detection units with the same configuration, an idle detection unit therein can be selected by, for example, polling, for distribution of this type of object to detect.

FIG. 8 is a flow chart of the processing by a detection unit for detecting an object to detect allocated to this unit. Firstly, receive a required type of object to detect from the data distribution unit (step 810); then take the received object to detect as input data, execute a dedicated detection operator configured for the detection unit according to a pre-configured detection knowledge base to generate a type of network intrusion detection event (step 820); finally, send the network attack alarm event generated by the detection unit to the comprehensive analysis verification unit (step 830).

The execution operations of the detection units in the intrusion detection device in this embodiment are independent of one another, thus in actual implementation of the present invention, a multi-core hardware platform may be utilized to achieve parallel running of the detection units in the detection grid, thereby largely improving the execution efficiency of the intrusion detection unit.

FIG. 9 is a flow chart of the processing by the comprehensive analysis verification unit. Firstly, receive a sequence of network attack alarm events sent by the detection units (step 910); then comprehensively analyze the network attack alarm event sequence to generate higher level network attack alarm events (step 920); finally, send these network attack alarm events to an alarm console or a third party security control device for threat resistance (step 930).

The comprehensive analysis verification unit may apply methods such as statistical analysis, correlation analysis, sequence pattern mining, cluster analysis, log similarity fusion, intrusion process discovery based on attack premise, risk evaluation combining assets and vulnerabilities, and so on. Applicable analysis models include sequence pattern mining model and attack scenario replay model, and the comprehensive analysis of the network attack alarm event sequence may include: 1) searching the sequence for attack modes that occur frequently, simplify the massive log and improving the administrator's capability of processing the massive log information; 2) timely discovering large scale network security events hidden in the massive log and evaluating the network security situation; 3) mining valuable attack sequence information from the massive log to generate a high level view of intrusion behaviors of an attacker, in order to instruct the administrator to carry out effective precaution.

The comprehensive analysis verification unit can receive environmental information data from the data pre-processing unit for implementing correlation analysis and validity verification of network attack events. For example, a detection unit detects a remote buffer overflow attack attempt specially aiming at a vulnerability of the Windows remote procedure call service, but finds out through the environmental information data that the operating system of the target host is Linux system, then the comprehensive analysis verification unit may identify this network attack event as an invalid attack event, thereby largely decreasing the event handling workload of the security administrator.

The comprehensive analysis verification unit may also receive vulnerability data information from a third party to implement validity verification of network attack events. For example, a detection unit detects a remote buffer overflow attack attempt specially aiming at a specific type of vulnerability of the Windows remote procedure call service, but finds out through the third party vulnerability data information that the remote procedure call service of the target host does not have such type of vulnerability, then the comprehensive analysis verification unit may identify this network attack event as an invalid attack event, thereby largely decreasing the event handling workload of the security administrator.

Although the present invention is described by embodiments, those skilled in the art should know that the present invention may have many modifications and variations without departing from the spirit of the present invention, and these modifications and variations shall be included in the appended claims without departing from the spirit of the present invention.

What we claim is:

1. A method for intrusion detection, comprising:
allocating one or more detection units in an intrusion detection device for each type of network attack event to detect;
configuring the type of object to detect of this type of network attack event, as well as a detection operator and a detection knowledge base to be used in intrusion detection of this type of object to detect; and
during the intrusion detection, said intrusion detection device performing the following processing:
acquiring network data packets in real time and pre-processing the network data packets to obtain the objects to detect in intrusion detection included in said network data packets; and
according to the types of the acquired objects to detect, corresponding detection units performing intrusion detection based on detection operators and detection knowledge bases configured for these types of objects to detect, and generating network attack alarm events.

2. The method as claimed in claim 1, further comprising:
before the intrusion detection, generating a process tree of objects to detect according to the types of objects to detect configured, with leaf nodes of the process tree of objects to detect being objects to detect configured, and other nodes being intermediate objects required to be obtained during processing of the network data packets for obtaining the objects to detect corresponding to the lower layer leaf nodes; and
during the intrusion detection, said intrusion detection device only processing the intermediate objects in said process tree of objects to detect layer by layer to finally obtain the objects to detect in detection.

3. The method as claimed in claim 1, wherein,
in said intrusion detection device, a multi-core hardware platform is employed for achieving parallel running of at least part of the detection units in intrusion detection.

4. The method as claimed in claim 1, further comprising:
after generating the network attack alarm events, said intrusion detection device comprehensively analyzing the network attack alarm events to generate higher level network intrusion attack events.

5. The method as claimed in claim 4, further comprising:
when pre-processing the acquired network data packets, said intrusion detection device collecting environmental information data of a monitored network, including a fingerprint of an operating system and/or a fingerprint of an application system; and
after generating the network attack alarm events, said intrusion detection device comprehensively analyzing the generated network attack alarm events by using said environmental information data to verify the validity of the attack events.

6. A device for intrusion detection of network attack events, comprising a data pre-processing unit, a data distribution unit and a detection grid which are connected sequentially, and a configuration management unit connecting with the data pre-processing unit, data distribution unit and detection grid, said detection grid comprising one or more detection units, wherein:
said configuration management unit comprises a customization subunit for allocating one or more detection units for each type of network attack event and configuring a type of object to detect of a type of network attack event to detect for each detection unit as well as a detection operator and a detection knowledge base to be used in intrusion detection;
said data pre-processing unit is used to pre-process network data packets acquired in real time according to the types of objects to detect configured, in order to obtain the objects to detect in intrusion detection included in the network data packets and transfer the objects to detect to said data distribution unit;
said data distribution unit is used to distribute the received objects to detect to corresponding detection units according to the types of objects to detect configured for the detection units; and
each of the detection unit in said detection grid is used to scan and detect the object to detect distributed to the detection unit by using the configured detection operator and detection knowledge base, so as to generate a network attack alarm event.

7. The intrusion detection device as claimed in claim 6, wherein,
said configuration management unit further comprises a process tree generation subunit for generating a process tree of objects to detect according to the types of objects to detect configured, with leaf nodes of the process tree of objects to detect being the objects to detect configured, and other nodes being intermediate objects required to be obtained during processing of the network data packets for obtaining the objects to detect corresponding to the lower layer leaf nodes; and
when pre-processing the network data, said data pre-processing unit only processes the intermediate objects in said process tree of objects to detect layer by layer to obtain the objects to detect in detection.

8. The device as claimed in claim 6, wherein,
said detection grid is realized based on a multi-core hardware platform, and at least part of the detection units can run in parallel during intrusion detection.

9. The device as claimed in claim 6, further comprising a comprehensive analysis verification unit, wherein,
each of the detection units is further used to report the generated network attack alarm event to said comprehensive analysis verification unit; and
said comprehensive analysis verification unit is used to comprehensively analyze a network attack event sequence reported by, the detection units to generate higher level network intrusion attack events.

10. The device as claimed in claim 9, wherein,
when pre-processing the network data packets, said data pre-processing unit further collects environmental information data of a monitored network from the network data packets, the environmental information data including a fingerprint of an operating system and/or a fingerprint of an application system, and sends these environmental information data to said comprehensive analysis verification unit; and
when comprehensively analyzing said network attack alarm event sequence, said comprehensive analysis verification unit uses said environmental information data to comprehensively analyze the generated network attack alarm events, so as to verify the validity of the attack events.

11. The device as claimed in claim 6, wherein,
said customization subunit is further used to reconfigure the detection units in the detection grid, including updating the detection operator and detection knowledge base of a detection unit, allocating a detection unit for a new type of network attack event and configuring the type of object to detect, the detection operator and the detection knowledge base, and releasing an allocated detection unit and deleting corresponding configuration information.

12. The device as claimed in claim 6, wherein,
said customization subunit allocates one or more detection units for each type of network attack event according to the occurrence frequency of each type of network attack event, and configures the type of object to detect of this type of network attack event for these detection units; and
when a type of object to detect corresponds to a group of detection units with the same configuration, said data distribution unit distributes the object to detect to an idle detection unit in the detection units.

13. The method as claimed in claim 2, wherein,
in said intrusion detection device, a multi-core hardware platform is employed for achieving parallel running of at least part of the detection units in intrusion detection.

14. The method as claimed in claim 2, further comprising:
after generating the network attack alarm events, said intrusion detection device comprehensively analyzing the network attack alarm events to generate higher level network intrusion attack events.

15. The device as claimed in claim 7, wherein,
said detection grid is realized based on a multi-core hardware platform, and at least part of the detection units can run in parallel during intrusion detection.

16. The device as claimed in claim 7, further comprising a comprehensive analysis verification unit, wherein,
each of the detection units is further used to report the generated network attack alarm event to said comprehensive analysis verification unit; and
said comprehensive analysis verification unit is used to comprehensively analyze a network attack event sequence reported by the detection units to generate higher level network intrusion attack events.

17. The device as claimed in claim 7, wherein,
said customization subunit is further used to reconfigure the detection units in the detection grid, including updating the detection operator and detection knowledge base of a detection unit, allocating a detection unit for a new type of network attack event and configuring the type of object to detect, the detection operator and the detection knowledge base, and releasing an allocated detection unit and deleting corresponding configuration information.

18. The device as claimed in claim 7, wherein,
said customization subunit allocates one or more detection units for each type of network attack event according to the occurrence frequency of each type of network attack event, and configures the type of object to detect of this type of network attack event for these detection units; and
when a type of object to detect corresponds to a group of detection units with the same configuration, said data distribution unit distributes the object to detect to an idle detection unit in the detection units.
